(19) United States
(12) Patent Application Publication
(10) Pub. No.: US 2024/0337495 A1
(43) Pub. Date: Oct. 10, 2024

(54) APPARATUS AND METHOD FOR DISPLAYING INDOOR DRIVING INFORMATION USING MAP INFORMATION AND MOTION SENSOR

(71) Applicants: HYUNDAI MOTOR COMPANY, Seoul (KR); KIA CORPORATION, Seoul (KR); Hyundai Autoever Corp, Seoul (KR)

(72) Inventors: Kim Chihwan, Hwaseong-si (KR); Sung Taehyun, Hwaseong-si (KR); JunHo Kim, Seoul (KR)

(73) Assignees: HYUNDAI MOTOR COMPANY, Seoul (KR); KIA CORPORATION, Seoul (KR); Hyundai Autoever Corp, Seoul (KR)

(21) Appl. No.: 18/530,944

(22) Filed: Dec. 6, 2023

(30) Foreign Application Priority Data
Apr. 6, 2023 (KR) 10-2023-0045099

(51) Int. Cl. G01C 21/20; G01C 21/36

(52) U.S. Cl. CPC G01C 21/206; G01C 21/367

(57) ABSTRACT

Provided herein are an apparatus and method for displaying indoor driving information using map information and a motion sensor. A driving information display apparatus includes: a motion sensor configured for measuring the motion of a vehicle; a processor operatively connected to the motion sensor and configured to receive information related to the location of the vehicle and a change in the height of the vehicle, and to perform control to output a map around the vehicle; and a storage unit operatively connected to the processor and configured to store the map information of an indoor space composed of a plurality of floors and an algorithm run by the processor. The processor is further configured to check whether the vehicle has reached a link for entry to the indoor space, and when the vehicle enters the indoor space, identify the floor on which the vehicle is located, and perform control to output a map corresponding to the identified floor.

### CROSS-REFERENCE TO RELATED APPLICATION

The present application claims priority to Korean Patent Application No. 10-2023-0045099 filed on Apr. 6, 2023, the entire contents of which is incorporated herein for all purposes by this reference.

### BACKGROUND OF THE PRESENT DISCLOSURE

### Field of the Present Disclosure

The present disclosure relates to an apparatus and method for displaying indoor driving information using map information and a motion sensor, and more particularly, to an apparatus that enables the location of a vehicle to be accurately measured without the installation of an additional facility even in a radio-shadow state where Global Positioning System (GPS) signals are not checked when displaying driving information in an indoor section such as an underground parking lot, and a method of operating the apparatus.

### Description of Related Art

With the development of location information and geographic information processing technology using the Global Positioning System (GPS) and/or the like, various types of driving information are provided while a vehicle is driving. In particular, recently, as it has become possible to measure the location of a vehicle even in an indoor section of a related art, driving guidance has become available in indoor spaces.

However, to measure the location of a vehicle in an indoor space where Global Positioning System (GPS) signals are not checked, a communication device such as a beacon needs to be additionally installed in the indoor space as in the related art. In a space where such a communication device is not installed, a problem arises in that it is difficult to measure the location of a vehicle.

When an indoor space is composed of a plurality of floors, it is difficult to identify the floor on which a vehicle is located, so that there is a limitation in terms of the display of driving information in such indoor spaces. Therefore, there is a demand for technology capable of providing guidance on the driving of a vehicle even in an indoor space where an additional facility for the positioning of a vehicle is not installed.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing information based on the location of a vehicle in an indoor space.

An object of the present disclosure is to accurately identify the location of a vehicle even in an indoor space where an additional facility such as a beacon is not installed.

An object of the present disclosure is to accurately identify a floor on which a vehicle is located in an indoor space composed of a plurality of floors.

An object of the present disclosure is to minimize an error in the location of a vehicle in an indoor space.

The objects to be achieved as an exemplary embodiment of the present disclosure are not limited to the objects described above, and other objects may be clearly understood by those skilled in the art from the following detailed description of the present disclosure.

According to various aspects of the present disclosure, there is provided a driving information display apparatus including: a motion sensor configured for measuring the motion of a vehicle: a processor operatively connected to the motion sensor and configured to receive information related to the location of the vehicle and a change in the height of the vehicle measured by the motion sensor, and to perform control to output a map around the vehicle based on the information related to the location of the vehicle and the change in the height of the vehicle; and a storage unit operatively connected to the processor and configured to store the map information of an indoor space composed of a plurality of floors and an algorithm run by the processor: wherein the processor is further configured to: check whether the vehicle has reached a link for entry to the indoor space based on the information related to the location of the vehicle: and when the vehicle enters the indoor space, identify the floor of the indoor space, on which the vehicle is located, based on the information related to the location of the vehicle and the measured change in the height of the vehicle, and perform control to output a map corresponding to the identified floor out of the map information stored in the storage unit.

The map information of the indoor space composed of the plurality of floors may include information related to the locations of the entrance and exit of a link for movement of the vehicle between the floors and an expected height change through the link; and the processor may be further configured to: check whether the vehicle has reached the entrance of the link for the movement between the floors based on the information related to the location of the vehicle: and when a cumulative change in the height of the vehicle after reaching of the entrance of the link is greater than a value obtained by multiplying the expected height change of the link by a predetermined rate, determine that the movement of the vehicle between the floors through the link has been completed, and perform control to output a map of a destination floor among the plurality of floors.

The processor may be further configured to perform control to output a map of a departure floor when the location of the vehicle is moved away from a location of the link by a predetermined reference value or more than the predetermined reference value before the cumulative change in the height of the vehicle after reaching of the link for the movement between the floors becomes greater than the value obtained by multiplying the expected height change of the link by the predetermined rate.

The processor may be further configured to, when it is determined that the vehicle has moved between the floors through the link, determine the location of the vehicle on the map of the destination floor based on the information related to the motion of the vehicle, measured by the motion sensor, by use of a location of the exit of the link located on the destination floor as a reference point, and perform control to display the location of the vehicle on the map.

The map information of the indoor space composed of the plurality of floors may further include information related to the locations of one or more roads, through which vehicles can move, in a map of each of the floors; and the processor may be further configured to: compare the determined location of the vehicle with information related to the locations of one or more roads included in the map information of the floor on which the vehicle is located; and correct the location of the vehicle to a location on a road closest to the determined location of the vehicle.

The processor may be further configured to: check the information related to the motion of the vehicle measured by the motion sensor; and correct the information related to the motion of the vehicle to match the direction of a road included in the map information of the floor on which the vehicle is located when the moving direction of the vehicle does not match the direction of the road.

The map information of the indoor space composed of the plurality of floors may further include vehicle motion pattern information upon the movement of the vehicle between the floors for each link for the movement of the vehicle between the floors; and the processor may be further configured to determine that the movement of the vehicle between floors has been made when the information related to the motion of the vehicle after reaching of the entrance of the link for the movement of the vehicle between the floors matches the vehicle motion pattern information upon the movement of the vehicle between the floors for the link.

The map information of the indoor space composed of the plurality of floors may further include information related to parking spaces for each floor; and the processor may be further configured to: receive occupancy information for each parking space of the floor on which the vehicle is located; and perform control to display the occupancy information on the map.

The processor may be further configured to: receive information related to the destination of the vehicle; when the destination is located on the floor on which the vehicle is located, display a route from the location of the vehicle to the destination on the map: and when the destination is located on a floor different from the floor on which the vehicle is located, display a route, leading to the entrance of a link for movement to the floor on which the destination is located, on the map.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram showing the internal configuration of a driving information display apparatus according to various exemplary embodiments of the present disclosure;

FIG. 2 is a view showing an example of displaying a map of an indoor space when a vehicle enters the indoor space in a driving information display apparatus according to various exemplary embodiments of the present disclosure:

FIG. 3 is a view showing an example of displaying a map of an indoor space when a vehicle reaches a link for movement to another floor in a driving information display apparatus according to various exemplary embodiments of the present disclosure:

FIG. 4 is a diagram showing an example of correcting and displaying the location of a vehicle in a driving information display apparatus according to various exemplary embodiments of the present disclosure:

FIG. 5 is a diagram showing an example of displaying whether parking spaces are occupied in a driving information display apparatus according to various exemplary embodiments of the present disclosure:

FIG. 6 is a diagram showing an example of guiding a vehicle through a route in an indoor space in a driving information display apparatus according to various exemplary embodiments of the present disclosure;

FIG. 7 is a flowchart showing the flow of a method of identifying a floor on which a vehicle is located in a driving information display apparatus according to various exemplary embodiments of the present disclosure; and

FIG. 8 is a flowchart showing the flow of a driving information display method according to various exemplary embodiments of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings. In the following description of the present disclosure, when it is determined that a detailed description of a related known configuration or function may obscure the gist of the present disclosure, the detailed description will be omitted. Furthermore, in the description of the exemplary embodiments of the present disclosure, predetermined numerical values are merely examples, and the scope of the present disclosure is not limited thereto.

In the description of the components of the exemplary embodiments of the present disclosure, terms such as first, second, A, B, (a), (b), etc. may be used. These terms are each used only to distinguish one component from other components, and the nature, sequence, or sequential position of the corresponding component is not limited by the term. Furthermore, unless defined otherwise, all the terms (including technical or scientific terms) used herein include the same meanings as commonly understood by those of ordinary skill in the art to which an exemplary embodiment of the present disclosure pertains. Terms such as those defined in commonly used dictionaries should be interpreted as including meanings consistent with the meanings in the context of the related art. Unless explicitly defined in the present application, these terms should not be interpreted as including ideal or excessively formal meanings.

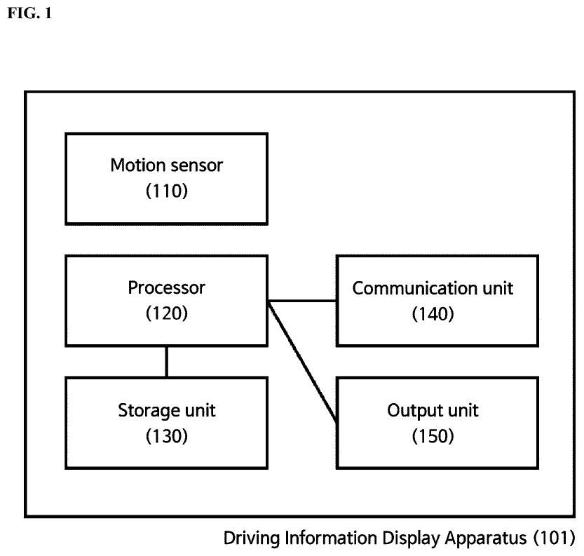

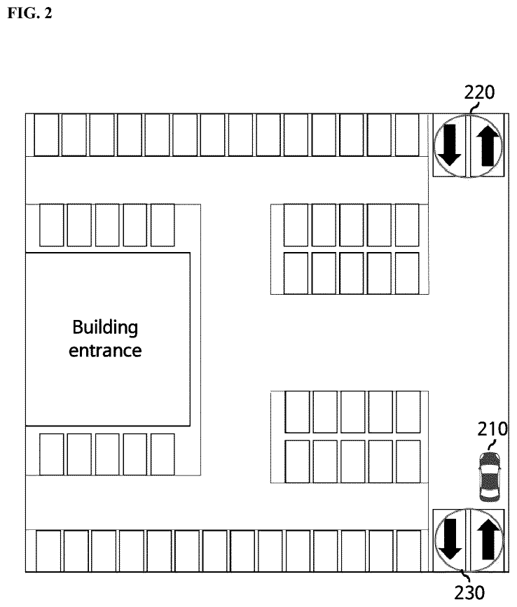

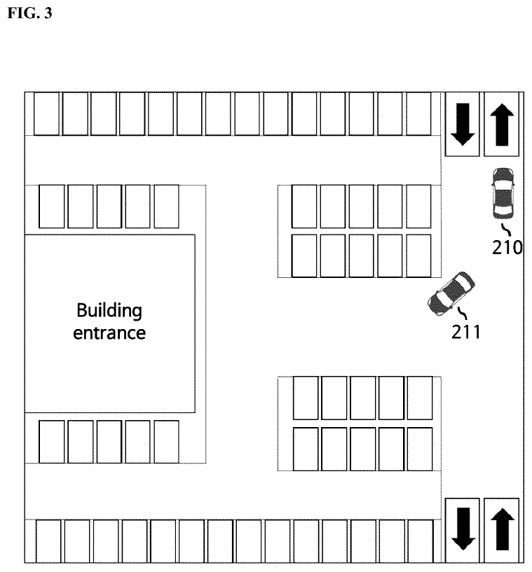

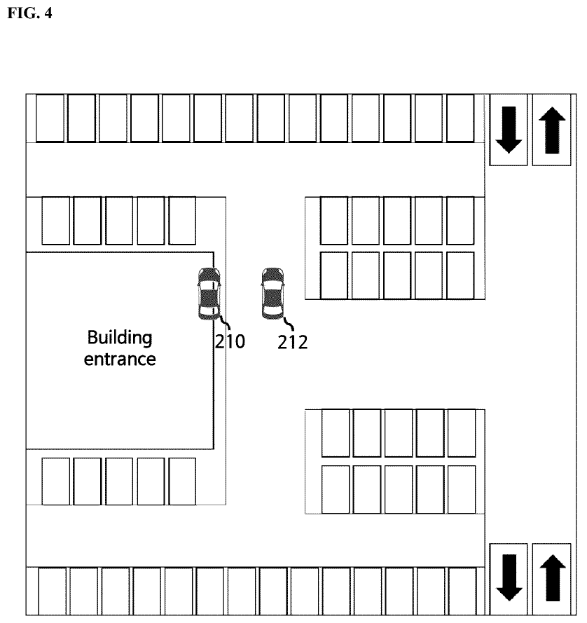

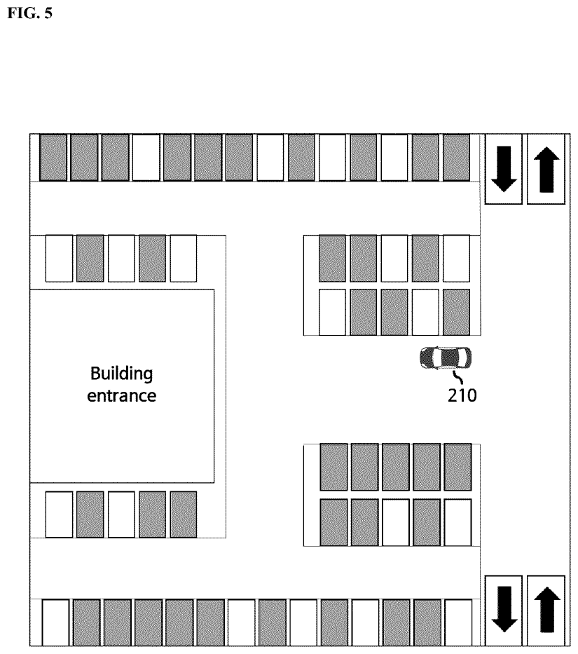

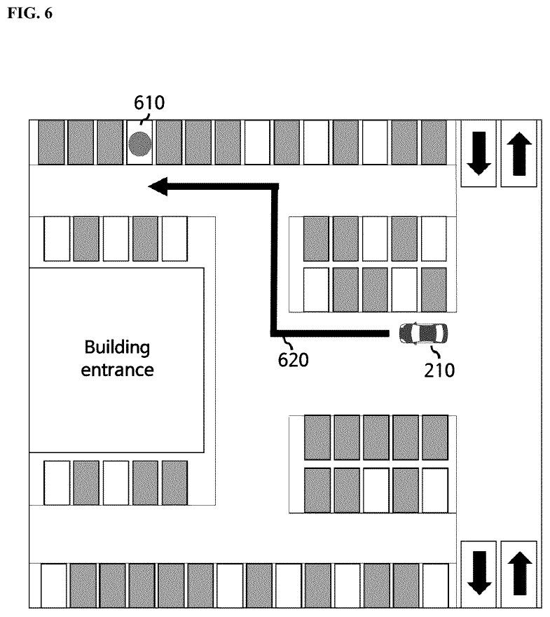

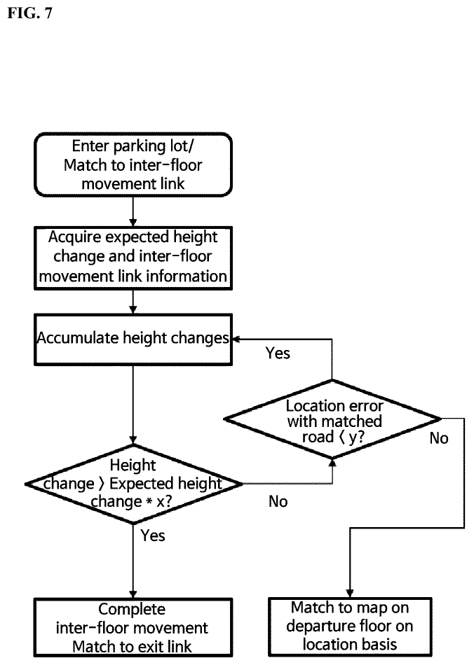

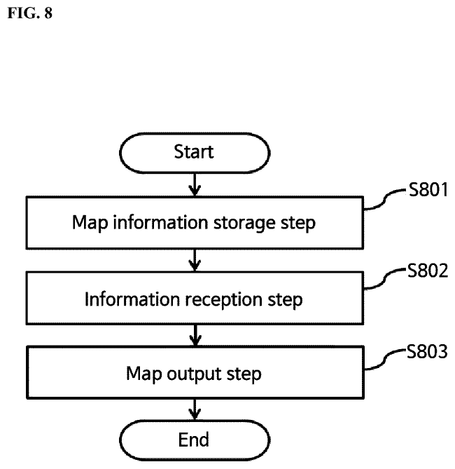

The exemplary embodiments of the present disclosure will be described in detail below with reference to FIG. 1, FIG. 2, FIG. 3, FIG. 4, FIG. 5, FIG. 6, FIG. 7, and FIG. 8.

FIG. 1 is a block diagram showing the internal configuration of a driving information display apparatus 101 according to various exemplary embodiments of the present disclosure.

The driving information display apparatus 101 according to the exemplary embodiment may be installed inside a means of transportation such as a vehicle, or may be implemented in a detachable form. The driving information display apparatus 101 may generally take the form of a vehicle navigation system, a vehicle Audio, Video and Navigation (AVN) system, a head-up display (HUD), or the like. The driving information display apparatus 101 may also be implemented in the form in which an application is installed on a mobile phone terminal such as a smartphone.

The driving information display apparatus 101 according to the exemplary embodiment may be present in a form of a server outside a means of transportation such as a vehicle. In the instant case, the driving information display apparatus may be implemented to, while being present outside the means of transportation, generate driving guidance information by processing determinations and output the guidance information to a display or the like inside the means of transportation. Furthermore, various embodiments may be implemented, but the scope of the present disclosure is not limited to the configurations of these embodiments.

Furthermore, the driving information display apparatus 101 according to the exemplary embodiment may be operated in conjunction with apparatuses for autonomous driving control such as an Advanced Driver Assistance System (ADAS), Smart Cruise Control (SCC), Forward Collision Warning (FCW), and/or the like.

As shown in the drawing, the driving information display apparatus 101 according to the exemplary embodiment may include a motion sensor 110, a processor 120, a storage unit 130, a communication unit 140, and an output unit 150.

The motion sensor 110 is a sensor configured for identifying the motion of a vehicle. The motion sensor 110 may include a single sensor, or may include a combination of various sensors to accurately identify the motion of a vehicle. For example, the motion sensor 110 may include a gyro sensor configured for checking the rotation direction of a vehicle, an acceleration sensor configured for measuring the acceleration of the vehicle, and a speed sensor configured for checking the speed of the vehicle.

Other types of sensors may be additionally used to accurately determine the movement of a vehicle. The scope of the present disclosure is not limited to a combination of specific sensors. However, since the movement of a vehicle between floors needs to be recognized based on a change in the vertical height of the vehicle in an indoor space, it is necessary to include a gyro sensor configured for measuring a change in the vertical height of the vehicle or a sensor configured for a function equivalent thereto.

The motion sensor 110 may be configured in various forms according to the configuration of the driving information display apparatus 101. One or more physical sensors may be directly disposed inside the driving information display apparatus 101. Alternatively, one or more sensors may be disposed inside the driving information display apparatus 101, one or more sensors may be disposed outside the driving information display apparatus 101, and sensing information may be combined and used. Furthermore, it may also be possible to receive sensing information from the electronic control unit (ECU) of a vehicle and utilize it. As described above, the motion sensor 110 refers to a module configured for measuring the motion of a vehicle. The motion sensor 110 may be configured for measuring the motion of a vehicle, particularly a change in the height of the vehicle in the vertical direction, through data without directly measuring a physical sensing value.

The processor 120 is configured to control the storage unit 130, the communication unit 140, and the output unit 150 to run an application, process data according to an algorithm defined in the application, and provide the results of the processing to a user while communicating with an external module.

The processor 120 may refer to a chip for processing a general algorithm such as a central processing unit (CPU) or an application processor (AP), or a set of such chips. The processor 120 may refer to a chip optimized for floating-point arithmetic, such as a general-purpose computing on graphics processing unit (GPGPU), to process an artificial intelligence algorithm such as deep learning, or a set of such chips. Alternatively, the processor 120 may refer to a module in which various types of chips are connected and distributed to perform an algorithm and process data.

The processor 120 may be electrically connected to the storage unit 130 and the communication unit 140, may electrically control the individual components, may be an electric circuit that executes software commands, and may perform various types of data processing and determination to be described later. The processor 120 may be, for example, an electronic control unit (ECU), a micro-controller unit (MCU), or another lower level controller which is mounted on a means of transportation.

The storage unit 130 stores the map information of an indoor space composed of a plurality of floors and an algorithm run by the processor. The map information of an indoor space refers to a map of the indoor space that vehicles can enter, such as an underground parking lot. The map information includes per-floor maps for an indoor space composed of a plurality of floors, so that guidance information for a corresponding floor may be output only when the floor on which a vehicle is located is identified.

The map information stored in the storage unit 130 may include the location information of the entrance and exit of each link for movement between floors and an expected change in height in the link. A link is a path through which a vehicle moves between floors or between an indoor space and the outside thereof. The entrance of a link refers to a point where a vehicle starts to enter the link to move from a specific floor to another floor or move to an external space. The exit of a link refers to a point where the vehicle starts to enter the reached floor or the outside when the vehicle has moved to the other floor or to the outside through the corresponding link.

When a vehicle enters the entrance of a link for movement between floors, the vehicle moves to the exit of the link and moves to another floor. Accordingly, the floor on which a vehicle is located may be more accurately identified by storing and utilizing data on an exit floor for each link and an expected change in the height of the vehicle in the vertical direction on the exit floor.

Furthermore, when the movement between floors is performed through each link, pattern information for the motion of a vehicle may be stored. For example, in some links, a vehicle may move to another floor through a straight ramp, and in other links, a vehicle may move to another floor through a circular ramp. Furthermore, a link in which the two types of ramps are combined together may also be provided.

Therefore, when pattern information for the motion of a vehicle when the vehicle moves to another floor through a link is stored in the storage unit 130, it may be accurately determined whether the vehicle has actually moved to the other floor through the link by analyzing the motion of the vehicle.

Furthermore, the map information stored in the storage unit 130 may further include information related to the locations of one or more roads through which vehicles can move and information related to one or more parking spaces on a map of each floor. Even in an indoor space, roads on which vehicles can move are set, and parking spaces where vehicles may be parked are also set. Accordingly, when the above information is stored in the storage unit 130, information related to one or more roads through which a vehicle can move may be provided through a map. Furthermore, when the location of a vehicle is identified as a location to which the vehicle cannot move, the location of the vehicle may be accurately measured by determining that an error has occurred in the measurement of motion and then correcting the error.

Due to the characteristic of an indoor space in which it is difficult to receive Global Positioning System (GPS) signals, when the location of a vehicle is estimated by analyzing the motion of the vehicle, small errors may be accumulated and cause a significant error. Accordingly, the location of the vehicle may be continuously corrected using the above information, so that information may be provided based on the accurate location of the vehicle.

The storage unit 130 may have various forms, and may be at least one type of storage medium such as a flash memory-, hard disk-, micro-, card (e.g., secure digital (SD) card or extreme digital (XD)) card)-, random access memory (RAM)-, static RAM (SRAM)-, read-only memory (ROM)-, programmable ROM (PROM)-, electrically erasable PROM (EPROM)-, magnetic memory (MRAM)-, magnetic disk-, or optical disk-type storage medium, or the like. Depending on the amount, processing speed, storage time, and/or the like of data to be stored, a different type of storage medium or a combination of different types of storage media may be chosen.

The storage unit 130 may be implemented in a different form depending on whether the driving information display apparatus 101 according to the exemplary embodiment of the present disclosure is implemented inside or outside a means of transportation, the form in which the driving information display apparatus 101 according to the exemplary embodiment of the present disclosure is implemented, a communication method to be used, or the storage space or input/output speed of the storage unit 130. This is a part that a person skilled in the art can autonomously select according to the situation of implementation, and the scope of the present disclosure is not limited by changes in an implementation form.

The algorithm stored in the storage unit 130 may be implemented as a computer program in an executable form, and may be implemented to be stored in the storage unit 130 and then executed in a required situation. The algorithm stored in the storage unit 130 may be interpreted as being also implemented in an instruction form which is temporarily loaded into volatile memory and instructs the processor to perform specific operations.

The communication unit 140 receives information for driving guidance from the outside of the driving information display apparatus 101 of the present disclosure over a wired/wireless communication network, and transmits necessary information to an external module.

The communication unit 140 may receive the map information stored in the storage unit 130, an algorithm run by the processor 120, and the like from an external module, and may transmit information related to the current state of a means of transportation to the outside to obtain necessary information related to the transmitted information. For example, the communication unit 140 may continuously receive traffic information from a traffic information server to check real-time traffic information, and is configured to transmit the location and route information of a means of transportation, found through a module such as a GPS receiver, to the outside to obtain the real-time traffic information of an area related to the location and route of the means of transportation.

The communication unit 140 is a hardware device which is implemented using various electronic circuits to transmit and receive signals over a wireless or wired connection. In an exemplary embodiment of the present disclosure, the communication unit 140 may perform communication within a means of transportation using infra-transportation means network communication technology, and may perform Vehicle-to-Infrastructure (V2I) communication with a server, infrastructure, another means of transportation, and/or the like outside a means of transportation using wireless Internet access or short-range communication technology. In the instant case, the communication within a means of transportation may be performed using Controller Area Network (CAN) communication, Local Interconnect Network (LIN) communication, FlexRay communication, and/or the like as the infra-transportation means network communication technology. Furthermore, such wireless communication technology may include wireless LAN (WLAN), Wireless Broadband (WiBro), Wi-Fi, Worldwide Interoperability for Microwave Access (WiMAX), etc. Moreover, the short-range communication technology may include Bluetooth, ZigBee, Ultra-wideband (UWB), Radio Frequency Identification (RFID), Infrared Data Association (IrDA), etc.

The output unit 150 may output augmented reality information which is controlled by executing the algorithm, stored in the storage unit 130, via the processor 120. Augmented reality is a technology for enabling related information to be provided by adding graphic information to an image or scene of the real world.

The output unit 150 may be implemented as a head-up display (HUD), a cluster, an audio, video and navigation (AVN) system, a human-machine interface (HMI), and/or the like. Furthermore, the output unit 150 may include at least one of a liquid crystal display (LCD), a thin film transistor liquid crystal display (TFT LCD), a light emitting diode (LED) display, an organic light emitting diode (OLED) display, an active matrix OLED (AMOLED) display, a flexible display, a bended display, and a three-dimensional (3D) display. Some of these displays may be implemented as a transparent display configured in a transparent or translucent form to be able to view the outside thereof. Furthermore, the output unit 150 may be provided as a touch screen including a touch panel, and may be used as an input device as well as an output device.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

The driving information display apparatus 101 according to the exemplary embodiment may be implemented in different embodiments according to the method by which the processor 120 identifies the location of a vehicle and processes guidance information. Accordingly, the functions of the processor 120 will be divided into and described based on the exemplary embodiments below.

The processor 120 receives information related to the location of a vehicle and a change in the height of the vehicle measured by the motion sensor, and is configured to perform control to output a map around the vehicle based on the information related to the location of the vehicle and the change in the height of the vehicle. As for the information related to the location of a vehicle, in an outdoor space where GPS signals may be received as location information measured using the Global Positioning System (GPS), the location of the vehicle may be accurately identified, and a map may be output based on the identified location. However, since it is difficult to receive GPS signals in an indoor space, it is difficult to identify an accurate location and also it is difficult to identify the floor on which the vehicle is driving in the case of an indoor space composed of multiple floors.

Therefore, the processor 120 may accurately check the location of the vehicle to the maximum up to a section where the location of the vehicle may be identified using information related to the location of the vehicle, and may identify the location of the vehicle based on the motion of the vehicle measured by the motion sensor 110 in a space where it is difficult to check the location of the vehicle.

For example, the location of the vehicle may be identified using GPS signals up to an access road to an underground parking lot, the movement of the vehicle may be tracked through the combination of pieces of information including the rotation direction, acceleration, speed and/or the like of the vehicle based on the location of the vehicle finally identified through GPS signals, and the location of the vehicle may be determined through the above tracking. In the present method, even in the case where there is a small error in the information related to the rotation direction of the vehicle, when driving continues in an indoor space where GPS signals cannot be checked, such errors are accumulated, resulting in a significant error. Therefore, it is important to set a reference point to minimize error by continuously correcting the location of a vehicle.

The processor 120 is configured to determine whether the vehicle has reached a link for entry to an indoor space based on information related to the location of the vehicle, identifies the floor of the indoor space, on which the vehicle is located, based on information related to the location of the vehicle and a measured change in the height of the vehicle when the vehicle has entered the indoor space, and performs control to output a map corresponding to the identified floor and selected from the map information stored in the storage unit.

As described above, the location of the vehicle may be estimated based on the motion of the vehicle. Accordingly, when it is determined that the vehicle has reached a link for entry to an indoor space, the location of the vehicle is identified using information related to the motion of the vehicle thereafter. It is important to identify the floor on which the vehicle is located in an indoor space composed of multiple floors. The floor on which the vehicle is located may be identified by checking a change in the height of the vehicle in the vertical direction from information related to the motion of the vehicle.

To accurately identify the above, information related to the locations of the entrance and exit of each link for movement between floors and an expected height change through the link may be stored in the map information stored as described above, and the expected height change may be compared with an actual vehicle height change.

The processor 120 is configured to determine whether the vehicle has reached the entrance of the link for movement between floors based on the information related to the location of the vehicle, is configured to determine that the vehicle has moved between floors through the link when a cumulative change in the height of the vehicle after reaching of the entrance of the link is greater than the value obtained by multiplying the expected height change of the link by a predetermined rate, and performs control to output a map of a destination floor among the plurality of floors.

In the instant case, the information related to the location of the vehicle in the indoor space is obtained in a situation in which it is difficult to determine the location of the vehicle through GPS signals, so that it may be location information which is estimated using information related to the motion of the vehicle as described above.

When, as a result of checking the location information of the vehicle, it is determined that the vehicle reaches the entrance of the link for movement between floors, a change in the height of the vehicle in the vertical direction after reaching of the entrance may be cumulatively measured, and it may be determined that the movement between floors has been completed through the link when the cumulative change becomes equal to the expected height change of the corresponding link stored in the storage unit 130.

In the instant case, it is difficult to change the height of the vehicle to a value exactly identical to the expected height change due to the error of the motion sensor 110. Accordingly, the movement of the vehicle between floors is identified by comparing the actual height change with the value obtained by multiplying the expected height change by a predetermined rate within an approximate range. For example, when the link that a vehicle has entered is a link for downward movement from a first basement floor to a second basement floor, the expected height change of the link is 5 m, and the predetermined rate is 0.9, it is determined that the vehicle has moved from the first basement floor to the second basement floor when a cumulative height change after the entry to the link is equal to or greater than 4.5 m (5 m*0.9), and a map of the second basement floor may be output thereafter.

To accurately identify the movement of the vehicle between floors only using motion information, it is necessary to store the location and expected height change of each link for movement between floors and information related to the destination floor of the link together with map information in the storage unit 130 and utilize them. The location of the vehicle in the indoor space may be accurately measured without the installation of an additional facility such as a beacon simply by checking the above information in a process of constructing map information.

The processor 120 is configured to perform control to output a map of a departure floor when the location of the vehicle is moved away from a location of the link by a predetermined reference value or more than the predetermined reference value before the cumulative change in the height of the vehicle after reaching of the link for the movement between the floors becomes greater than the value obtained by multiplying the expected height change of the link by the predetermined rate.

To accurately check whether the vehicle has moved to another floor through the link, it is necessary to check whether a height change has actually been made through the link. In a situation in which the height change of the vehicle does not reach a predetermined percentage of the expected height change by the predetermined rate while the height of the vehicle is changing, when it is determined that the location of the vehicle in the horizontal direction is somewhere other than the location of the link, it may be determined that the vehicle stays on a departure floor without moving between floors. Accordingly, in the instant case, the processor 120 is configured to perform control to output a map of the departure floor.

When it is determined that the vehicle has moved between floors through the link, the processor 120 may be configured to determine the location of the vehicle on a map of a destination floor based on information related to the motion of the vehicle, measured by the motion sensor, by use of a location of the exit of the link located on the destination floor as a reference point, and may perform control to display the location of the vehicle on the map.

When it is determined that the vehicle has completed the movement between floors through the link, the vehicle is located at the exit of the link on the floor to which the vehicle can move through the corresponding link. Accordingly, the movement of the vehicle on the floor to which the vehicle has moved is determined through motion information by use of the exit point of the link as a reference point.

As described above, when GPS signals which may be used to determine the absolute location of the vehicle are not available, the relative location of the vehicle needs to be determined through the motion of the vehicle. A significant error may occur when small errors are accumulated, so that it is necessary to correct the interim location of the vehicle by setting a reference point. Accordingly, when the vehicle has moved to another floor through the link, it is obvious that the vehicle is located at the exit of the link on a destination floor, so that the location of the vehicle may be relatively estimated based on the motion of the vehicle using the present location as a reference point.

The items described so far will be described based on FIG. 2 and FIG. 3.

FIG. 2 is a view showing an example of displaying a map of an indoor space when a vehicle enters the indoor space in a driving information display apparatus according to various exemplary embodiments of the present disclosure.

For example, when a vehicle enters an indoor space on a first basement floor from the outside thereof, the map shown in FIG. 2 is a map of the first basement floor.

Reference numeral 220 denotes the entrance (the right side) of a link for downward movement to a second basement floor and the exit (the left side) of a link for upward movement from the second basement floor, and reference numeral 230 denotes the exit (the right side) of a link for entry from the outside thereof and the entrance (the left side) of a link for exit to the outside thereof.

When the movement of the vehicle 210 from the outside thereof to a link for access to an underground parking lot is recognized through information related to the location of the vehicle obtained using GPS signals or the like, it is checked whether the change in the height of the vehicle is greater than a predetermined percentage of the expected height change of the corresponding link (the link connected from the outside thereof to a first basement floor) by a predetermined rate as described above. When there is such a change in the height of the vehicle, it may be determined that movement of the vehicle between floors has been made to the first basement floor.

Therefore, the processor 120 is configured to determine that the vehicle 210 is located on the first basement floor, outputs the information of the first basement floor onto a screen, and recognizes that the vehicle is located at the exit of the link 230 from the outside thereof to the first basement floor to which the vehicle is determined to be moved. In the instant case, when the motion of the vehicle is detected, it is determined that the vehicle performs relative movement on the first basement floor according to the motion, and the location of the vehicle is determined through the relative movement and displayed on a map.

FIG. 3 is a view showing an example of displaying a map of an indoor space when a vehicle reaches a link for movement to another floor in a driving information display apparatus according to various exemplary embodiments of the present disclosure.

As shown in the drawing, when the vehicle 210 reaches a link for movement from the first basement floor to the second basement floor, the processor 120 cumulatively checks a change in the height of the vehicle, and is configured to determine whether movement between floors has been made by comparing the cumulative change in the height of the vehicle with the expected height change of the link from the first basement floor to the second basement floor, which is stored in the storage unit 130.

In the instant case, when the change in the height of the vehicle is greater than a predetermined percentage of the expected height change of the link connected from the first basement floor to the second basement floor, it is determined that the movement to the second basement floor has been made, and the location of the vehicle is displayed based on a map of the second basement floor as in the case of FIG. 2 and is then tracked.

However, in a situation in which the change in the height of the vehicle is not greater than the predetermined percentage of the expected height change of the link connected from the first basement floor to the second basement floor, when the movement of the vehicle is made in a direction away from the link and thus the location of the vehicle is identified as the location of reference numeral 211, it may be determined that the vehicle has not moved to another floor through the corresponding link but has moved within the first basement floor, which is a departure floor.

Therefore, in the instant case, a map of the first basement floor on which the vehicle was initially located is output, and the location of the vehicle on the first basement floor is tracked and provided using motion information.

To more accurately identify whether the vehicle has actually moved between floors, the map information stored in the storage unit 130 further includes vehicle motion pattern information upon movement between floors for each link for movement between floors. Furthermore, the processor 120 may be configured to determine that the movement of the vehicle between floors has been made when information related to the motion of the vehicle after reaching of the entrance of the link for movement between floors matches vehicle motion pattern information upon movement between floors for the link.

As described above, the link for movement between floors may be configured in various forms. The link for movement between floors may be designed to allow a vehicle to move to another floor along a straight ramp or to allow a vehicle to move to another floor along a circular ramp. Accordingly, when the vehicle moves to another floor through an actual link, a pattern identical to a vehicle motion pattern in the corresponding link may be identified from information related to the motion of the vehicle.

For example, when a link is configured to move to another floor through a circular ramp, a vehicle exhibits movement in a rotating form while the height of the vehicle is changing. In a link in which movement between floors is performed through a straight ramp, the movement of a vehicle in a straight form is identified while the height of the vehicle is changing. When a different type of motion is identified from the pattern upon movement between floors in the link that the vehicle has entered, there is a high possibility that actual movement between floors is not performed and the vehicle is moving on a departure floor. In the instant case, the processor 120 is configured to perform control to continuously output a map of the departure floor.

As described above, to minimize error when estimating the location of the vehicle through motion information, it is necessary to appropriately correct the interim location of the vehicle. To the present end, the map information stored in the storage unit 130 further includes information related to the locations of one or more roads, through which vehicles can move, in a map of each floor. Furthermore, the processor 120 may compare the determined location of the vehicle with information related to the locations of one or more roads included in the map information of the floor on which the vehicle is located, and may correct the location of the vehicle to a location on the road closest to the determined location of the vehicle.

Even in an indoor space, roads where vehicles can move and spaces where vehicles cannot move are separated from each other. Accordingly, when the location of the vehicle estimated through the motion of the vehicle is recognized as a space where the vehicle cannot move, it may be determined that the estimation is incorrect, and the location of the vehicle may be corrected to a location on a road.

FIG. 4 is a diagram showing an example of correcting and displaying the location of a vehicle in a driving information display apparatus according to various exemplary embodiments of the present disclosure.

As shown in the drawing, when the location of a vehicle is identified as the location of reference numeral 210 as a result of estimating the location of the vehicle through the motion of the vehicle, there is a considerably low possibility that the vehicle is actually present at that location. Accordingly, the present case corresponds to a case where an error occurs in the estimation of the location using motion information. Meanwhile, when such errors continue to be accumulated, it becomes difficult to accurately determine the location of the vehicle.

Accordingly, when the location of the vehicle estimated based on the motion information is a space where the vehicle cannot be located, as indicated by reference numeral 210 in the drawing, the processor 120 may be configured to determine that the vehicle is located on the closest road where the vehicle can move, and may correct the location of the vehicle to the location of reference numeral 212. In the instant case, it may be also possible to determine a location having the highest possibility that the vehicle is present, rather than the closest location in terms of distance, by taking into consideration the moving direction and speed of the vehicle and then correct the location of the vehicle to the location having the highest possibility.

Furthermore, in the case of a space such as an underground parking lot, there are many parking spaces. Although they are not roads, vehicles can enter the parking spaces. Accordingly, the parking spaces may be recognized as spaces where vehicle can move like roads. In some cases, information indicating whether each individual parking space is occupied may be received through the communication unit 140. In the instant case, it may also be possible to perform control so that one or more occupied parking spaces are recognized as spaces where vehicles cannot move and one or more unoccupied parking spaces are recognized as spaces where vehicles can move, such as roads.

Furthermore, the processor 120 may check information related to the motion of the vehicle measured by the motion sensor, and may correct the information related to the motion of the vehicle to match the direction of a road included in the map information of a floor on which the vehicle is located when the moving direction of the vehicle does not match the direction of the road.

The direction in which the vehicle can move is set on the map, so that, when there is a case where the vehicle moves in a different direction, it implies that there is an error in motion information. Referring to the maps of FIG. 2, FIG. 3 and FIG. 4 above, the roads on which vehicles can move extend in the vertical or horizontal direction thereof. Accordingly, the movement of the vehicle in a diagonal direction and the like may not be performed.

When it is determined that the vehicle is moving at an angle different from the angle of the direction in which the road extends, there is a considerably high possibility that the vehicle is actually moving along the direction of the road. Accordingly, in the instant case, a cumulative error may be minimized by correcting the driving direction and position of the vehicle based on the direction of the road.

The driving information display apparatus 101 of the present disclosure may provide various types of information through a map of an indoor space.

When the map information stored in the storage unit 130 further includes information related to parking spaces for each floor and occupancy information for each parking space may be received through the communication unit 140, the processor 120 may receive occupancy information for each parking space of a floor where a vehicle is located, and may display the occupancy information on a map.

FIG. 5 is a diagram showing an example of displaying whether parking spaces are occupied in a driving information display apparatus according to various exemplary embodiments of the present disclosure.

As shown in the drawing, when a vehicle enters a specific floor, occupancy information for each parking space may be checked through the communication unit 140 while a map of the corresponding floor is being output, and the location of the corresponding parking space may be marked with information related to whether the corresponding parking space is occupied. Through this, a driver may check whether there is a parking space available for parking the vehicle upon entering the floor, and may move directly to another floor without having to check inside when there is no unoccupied parking space. There may be various methods of displaying whether each parking space is occupied, and the present disclosure is not limited by the display methods.

Furthermore, the processor 120 may receive information related to a destination of the vehicle, may display a route from the location of the vehicle to the destination on a map when the destination is located on the floor on which the vehicle is located, and may display a route, leading to the entrance of a link for movement to the floor on which the destination is located, on a map when the destination is located on a floor different from the floor on which the vehicle is located.

As in the case of guiding a vehicle to a destination in an outdoor space, a vehicle may be guided through a route when there are a map and road information of the area where the vehicle is located and the information related to the location of the vehicle.

FIG. 6 is a diagram showing an example of guiding a vehicle through a route in an indoor space in a driving information display apparatus according to various exemplary embodiments of the present disclosure.

As shown in the drawing, when the driver checks the occupancy information for the parking spaces and selects a parking space for parking, a route to the corresponding space is displayed on a map, so that the driver can easily find the desired parking space.

In the instant case, when information related to whether another vehicle has set the corresponding parking space as a destination is received through the communication unit 140, the processor 120 may be configured to determine which vehicle will reach the corresponding parking space first through routes, and may output information related to guidance on parking in another parking space when the vehicle in question is predicted to reach the corresponding parking space later.

Furthermore, the processor 120 may accurately determine the floor on which the vehicle is located in the indoor space and the location of the vehicle on the corresponding floor, so that the processor 120 may perform control so that various types of information may be output along with a map.

FIG. 7 is a flowchart showing the flow of a method of identifying a floor on which a vehicle is located in a driving information display apparatus according to various exemplary embodiments of the present disclosure.

The drawing shows, as a flowchart, a process which is performed from the time when a vehicle reaches a link for movement between floors to check whether the vehicle has moved between floors.

First, when the vehicle reaches the entrance of a link for movement between floors or entry to an indoor space, the storage unit 130 is checked to determine the expected height change of the link and the floors connected through the link.

Furthermore, the processor 120 continuously checks whether a cumulative change in the height of the vehicle exceeds a predetermined percentage of the expected height change while accumulating changes in the height of the vehicle measured through the motion sensor 110.

When the cumulative change in the height of the vehicle exceeds the predetermined percentage of the expected height change, it may be determined that the movement between floors is completed, and a map of the floor to which the vehicle may be moved through the link may be output. Furthermore, it may be determined that the vehicle is located at the location of the exit of the link on the destination floor through which the vehicle exits from the link when entering the link, and then continuous guidance may be provided based on information related to the motion of the vehicle.

When the difference between the path on which the vehicle moves through the link and the actual location of the vehicle is detected at a predetermined level or higher before the cumulative change in the height of the vehicle exceeds the predetermined percentage of the expected height change, it may be determined that the vehicle has not moved between floors but has moved within a departure floor.

Accordingly, the map information of the departure floor may be output, and guidance may continue based on the determination that the vehicle has moved within the departure floor.

FIG. 8 is a flowchart showing the flow of a driving information display method according to various exemplary embodiments of the present disclosure.

The driving information display method according to the exemplary embodiment of the present disclosure is a method which is performed in the driving information display apparatus 101 equipped with the processor 120 and the storage unit 130, and the configurations described in conjunction with the operation of the driving information display apparatus 101 may be applied to the driving information display method without change. Accordingly, it may be possible for those skilled in the art to implement configurations not specifically described in connection with the driving information display method below by applying descriptions of the above-described driving information display apparatus 101.

In a map information storage step S801, the map information of an indoor space composed of a plurality of floors is stored.

In the instant case, the map information may include information related to the locations of the entrance and exit of each link for movement between floors and an expected height change through the link.

Furthermore, the map information may further include information related to the locations of one or more roads, through which a vehicle may move, on a map of each floor.

Furthermore, the map information may further include vehicle motion pattern information upon movement between floors for each link for movement between floors.

Furthermore, the map information may further include information related to parking spaces for each floor.

In an information reception step S802, there are received information related to the location of a vehicle and information related to the motion of the vehicle measured by a motion sensor.

In a map output step S803, it is checked whether the vehicle has reached a link for entry to the indoor space based on the information related to the location of the vehicle, the floor of the indoor space on which the vehicle is located is identified based on the information related to the location of the vehicle and a measured change in the height of the vehicle when the vehicle enters the indoor space, and control is performed to output a map corresponding to the identified floor out of the map information stored in the storage unit.

In the map output step S803, it may be checked whether the vehicle has reached the entrance of the link for entry to the indoor space based on the information related to the location of the vehicle, it may be determined that movement between floors has been made through the link when a cumulative change in the height of the vehicle after reaching of the entrance of the link is greater than a value obtained by multiplying the expected height change of the reached link by a predetermined rate x disclosed in FIG. 7, and control may be performed to output a map of a destination floor.

Furthermore, in the map output step S803, when the location of the vehicle is moved away from the location of the link by a predetermined reference value y or more before the cumulative change in the height of the vehicle after reaching of the entrance of the link becomes greater than the value obtained by multiplying the expected height change of the reached link by the predetermined rate, control may be performed to output a map of a departure floor.

Furthermore, in the map output step S803, when it is determined that the vehicle has moved between floors through the link, the location of the vehicle is determined on a map of the destination floor based on information related to the motion of the vehicle, measured by the motion sensor, by use of the location of the exit of the link located on the destination floor as a reference point, and control is performed to display the location of the vehicle on the map.

In the map output step S803, the location of the vehicle may be compared with information related to the locations of one or more roads included in the map information of the floor on which the vehicle is located, and then the location of the vehicle may be corrected to a location on the road closest to the determined location of the vehicle.

Furthermore, in the map output step S803, information related to the motion of the vehicle measured by the motion sensor may be checked, and the information related to the motion of the vehicle may be corrected to match the direction of a road when the moving direction of the vehicle does not match the direction of the road included in the map information of the floor on which the vehicle is located.

Furthermore, in the map output step S803, when information related to the motion of the vehicle matches vehicle movement pattern information upon movement between floors through the link after the vehicle has reached the entrance of the link for movement between floors, it may be determined that the movement between floors has been made.

Furthermore, in the map output step S803, occupancy information for each parking space of the floor on which the vehicle is located may be received and displayed on a map.

Moreover, in the map output step S803, when the destination is located on the floor on which the vehicle is located, a route from the location of the vehicle to the destination may be displayed on the map. In contrast, when the destination is located on a floor different from the floor on which the vehicle is located, a route leading to the entrance of a link for movement to the floor on which the destination is located may be displayed on the map.

The driving information display method according to an exemplary embodiment of the present disclosure may be implemented as a program to be executed by a computer and recorded on a computer-readable storage medium.

Examples of the computer-readable storage medium include magnetic media such as hard disks, floppy disks and magnetic tapes, optical storage media such as CDROMs and DVDs, magneto-optical media such as floptical disks, and hardware devices specially configured to store and execute program instructions, such as ROM, RAM, flash memory, and the like.

Examples of the program instructions include high-level language codes which may be executed by a computer using an interpreter or the like as well as machine language codes such as those produced by a compiler. Each of the hardware devices may be configured to act as one or more software modules to perform processing according to an exemplary embodiment of the present disclosure, and vice versa.

The present disclosure may achieve an effect of providing information based on the location of a vehicle in an indoor space.

The present disclosure may achieve an effect of accurately identifying the location of a vehicle even in an indoor space where an additional facility such as a beacon is not installed.

The present disclosure may achieve an effect of accurately identifying a floor on which a vehicle is located in an indoor space composed of a plurality of floors.

The present disclosure may achieve an effect of minimizing an error in determining the location of a vehicle in an indoor space.

Furthermore, there may be provided various effects which may be directly or indirectly understood by those skilled in the art through the present specification.

In various exemplary embodiments of the present disclosure, each operation described above may be performed by a control device, and the control device may be configured by multiple control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A driving information display apparatus comprising:
a motion sensor configured for measuring a motion of a vehicle;
a processor operatively connected to the motion sensor and configured to receive information related to a location of the vehicle and a change in a height of the vehicle measured by the motion sensor, and to perform control to output a map around the vehicle based on the information related to the location of the vehicle and the change in the height of the vehicle; and
a storage unit operatively connected to the processor and configured to store map information of an indoor space composed of a plurality of floors and an algorithm run by the processor;
wherein the processor is further configured to:
check whether the vehicle has reached a link for entry to the indoor space based on the information related to the location of the vehicle; and
in response that the vehicle enters the indoor space, identify a floor of the indoor space, on which the vehicle is located, among the plurality of the floors, based on the information related to the location of the vehicle and the measured change in the height of the vehicle, and perform control to output a map corresponding to the identified floor out of the map information stored in the storage unit.

2. The driving information display apparatus of claim 1,
wherein the map information of the indoor space composed of the plurality of floors includes information related to locations of an entrance and an exit of a link for movement of the vehicle between the plurality of floors and an expected height change through the link, and
wherein the processor is further configured to:
check whether the vehicle has reached the entrance of the link for the movement between the plurality of floors based on the information related to the location of the vehicle; and
in response that a cumulative change in the height of the vehicle after reaching of the entrance of the link is greater than a value obtained by multiplying the expected height change of the link by a predetermined rate, determine that the movement of the vehicle between the plurality of floors through the link has been completed, and perform control to output a map of a destination floor among the plurality of floors.

3. The driving information display apparatus of claim 2, wherein the processor is further configured to perform control to output a map of a departure floor among the plurality of the floors in response that the location of the vehicle is moved away from a location of the link by a predetermined reference value or more than the predetermined reference value before the cumulative change in the height of the vehicle after reaching of the link for the movement between the plurality of floors becomes greater than the value obtained by multiplying the expected height change of the link by the predetermined rate.

4. The driving information display apparatus of claim 3, wherein the processor is further configured to, in response that the processor concludes that the vehicle has moved between the plurality of floors through the link, determine the location of the vehicle on the map of the destination floor based on the information related to the motion of the vehicle, measured by the motion sensor, by use of a location of the exit of the link located on the destination floor as a reference point, and perform control to display the location of the vehicle on the map.

5. The driving information display apparatus of claim 4,
wherein the map information of the indoor space composed of the plurality of floors further includes information related to locations of one or more roads, through which vehicles can move, in a map of each of the plurality of floors, and
wherein the processor is further configured to:
compare the determined location of the vehicle with information related to locations of one or more roads included in map information of the floor on which the vehicle is located; and
correct the location of the vehicle to a location on a road closest to the determined location of the vehicle.

6. The driving information display apparatus of claim 5, wherein the processor is further configured to:
check the information related to the motion of the vehicle measured by the motion sensor; and
correct the information related to the motion of the vehicle to match a direction of a road included in the map information of the floor on which the vehicle is located in response that a moving direction of the vehicle does not match the direction of the road.

7. The driving information display apparatus of claim 6,
wherein the map information of the indoor space composed of the plurality of floors further includes vehicle motion pattern information upon the movement of the vehicle between the plurality of floors for each link for the movement of the vehicle between the plurality of floors, and
wherein the processor is further configured to determine that the movement of the vehicle between floors has been made in response that the information related to the motion of the vehicle after reaching of the entrance of the link for the movement of the vehicle between the plurality of floors matches the vehicle motion pattern information upon the movement of the vehicle between the plurality of floors for the link.

8. The driving information display apparatus of claim 1,
wherein the map information of the indoor space composed of the plurality of floors further includes information related to parking spaces for each floor, and
wherein the processor is further configured to:
receive occupancy information for each parking space of the floor on which the vehicle is located; and
perform control to display the occupancy information on the map.

9. The driving information display apparatus of claim 1, wherein the processor is further configured to:
receive information related to a destination of the vehicle;
in response that the destination is located on the floor on which the vehicle is located, display a route from the location of the vehicle to the destination on the map; and
in response that the destination is located on a floor different from the floor on which the vehicle is located among the plurality of floors, display a route, leading to an entrance of a link for movement to the floor on which the destination is located, on the map.

10. A driving information display method which is performed in a driving information display apparatus provided with a processor and a storage unit, the driving information display method comprising:
a map information storage step of storing map information of an indoor space composed of a plurality of floors;
an information reception step of receiving information related to a location of a vehicle and information related to a motion of the vehicle measured by a motion sensor; and
a map output step of checking whether the vehicle has reached a link for entry to the indoor space based on the information related to the location of the vehicle, and in response that the vehicle enters the indoor space, identifying a floor of the indoor space, on which the vehicle is located, among the plurality of floors, based on the information related to the location of the vehicle and a measured change in a height of the vehicle and performing control to output a map corresponding to the identified floor out of the map information stored in the storage unit.

11. The driving information display method of claim 10,
wherein the map information of the indoor space composed of the plurality of floors includes information related to locations of an entrance and an exit of a link for movement of the vehicle between the plurality of floors and an expected height change through the link, and
wherein the map output step includes:
checking whether the vehicle has reached the entrance of the link for the movement of the vehicle between the plurality of floors based on the information related to the location of the vehicle; and
in response that a cumulative change in the height of the vehicle after reaching of the entrance of the link is greater than a value obtained by multiplying the expected height change of the link by a predetermined rate, determining that the movement of the vehicle between the plurality of floors through the link has been completed, and performing control to output a map of a destination floor among the plurality of floors.

12. The driving information display method of claim 11, wherein the map output step further includes:
performing control to output a map of a departure floor among the plurality of floors in response that the location of the vehicle is moved away from a location of the link by a predetermined reference value or more than the predetermined reference value before the cumulative change in the height of the vehicle after reaching of the link for the movement between the plurality of floors becomes greater than the value obtained by multiplying the expected height change of the link by the predetermined rate.

13. The driving information display method of claim 12, wherein the map output step further includes:
in response that the processor concludes that the vehicle has moved between the plurality of floors through the link, determining the location of the vehicle on the map of the destination floor based on the information related to the motion of the vehicle, measured by the motion sensor, by use of a location of the exit of the link located on the destination floor as a reference point, and performing control to display the location of the vehicle on the map.

14. The driving information display method of claim 13,
wherein the map information of the indoor space composed of the plurality of floors further includes information related to locations of one or more roads, through which vehicles can move, in a map of each of the plurality of floors, and
wherein the map output step further includes:
comparing the determined location of the vehicle with information related to locations of one or more roads included in map information of the floor on which the vehicle is located; and
correcting the location of the vehicle to a location on a road closest to the determined location of the vehicle.

15. The driving information display method of claim 14, wherein the map output step further includes:
checking the information related to the motion of the vehicle measured by the motion sensor; and
correcting the information related to the motion of the vehicle to match a direction of a road included in the map information of the floor on which the vehicle is located in response that a moving direction of the vehicle does not match the direction of the road.

16. The driving information display method of claim 15,
wherein the map information of the indoor space composed of the plurality of floors further includes vehicle motion pattern information upon the movement of the vehicle between the plurality of floors for each link for the movement of the vehicle between the floors, and
wherein the map output step further includes determining that the movement of the vehicle between the plurality of floors has been made in response that the information related to the motion of the vehicle after reaching of the entrance of the link for the movement of the vehicle between the plurality of floors matches the vehicle motion pattern information upon the movement of the vehicle between the plurality of floors for the link.

17. The driving information display method of claim 10,
wherein the map information of the indoor space composed of the plurality of floors further includes information related to parking spaces for each floor, and
wherein the map output step includes:
receiving occupancy information for each parking space of the floor on which the vehicle is located; and
performing control to display the occupancy information on the map.

18. The driving information display method of claim 10, wherein the map output step includes:
receiving information related to a destination of the vehicle;
in response that the destination is located on the floor on which the vehicle is located, displaying a route from the location of the vehicle to the destination on the map; and
in response that the destination is located on a floor different from the floor on which the vehicle is located, displaying a route, leading to an entrance of a link for movement to the floor on which the destination is located, on the map.

19. A computer-readable storage medium having stored thereon a program that causes a computer to perform the driving information display method of claim 10.
